(19) United States
(12) Patent Application Publication
(10) Pub. No.: US 2014/0211376 A1
(43) Pub. Date: Jul. 31, 2014

(54) SOLID CAPACITOR

(71) Applicant: HON HAI PRECISION INDUSTRY CO., LTD., New Taipei (TW)

(72) Inventors: JYUN-DA LIAO, New Taipei (TW); CHUN-YUAN TIEN, New Taipei (TW); CHIA-MING YEH, New Taipei (TW); YUN-WEN SU, New Taipei (TW)

(21) Appl. No.: 13/906,353

(22) Filed: May 31, 2013

(30) Foreign Application Priority Data
Jan. 28, 2013 (TW) 102103226

(51) Int. Cl. H01G 9/012

(52) U.S. Cl. CPC H01G 9/012
USPC 361/540

(57) ABSTRACT

A solid capacitor includes a body, a strip-shaped positive connection terminal and a strip-shaped negative connection terminal extending from the body comprising. Length directions of the positive connection terminal and the negative connection terminal are substantially parallel with each other while width directions of the positive connection terminal and the negative connection terminal are substantially perpendicular to each other.

### BACKGROUND

1. Technical Field

The present disclosure relates to solid capacitors and, more particularly, to a solid capacitor with low equivalent series inductance (ESL).

2. Description of Related Art

A conventional method to decrease equivalent series inductance (ESL) of a solid capacitor is by adding a ground terminal, however, it increases cost.

Therefore, it is desirable to provide a solid capacitor with low ESL.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments.

FIG. 1 is an isometric view showing a solid capacitor in a first embodiment.

FIG. 2 is similar to FIG. 1, but viewed at another angle.

FIG. 3 is an isometric view showing a solid capacitor in a second embodiment.

FIG. 4 is similar to FIG. 3, but viewed at another angle.

FIG. 5 is an isometric view showing a positive connection terminal of the solid capacitor in FIG. 1.

### DETAILED DESCRIPTION

Embodiments of the present disclosure will be described below, with reference to the accompanying drawings.

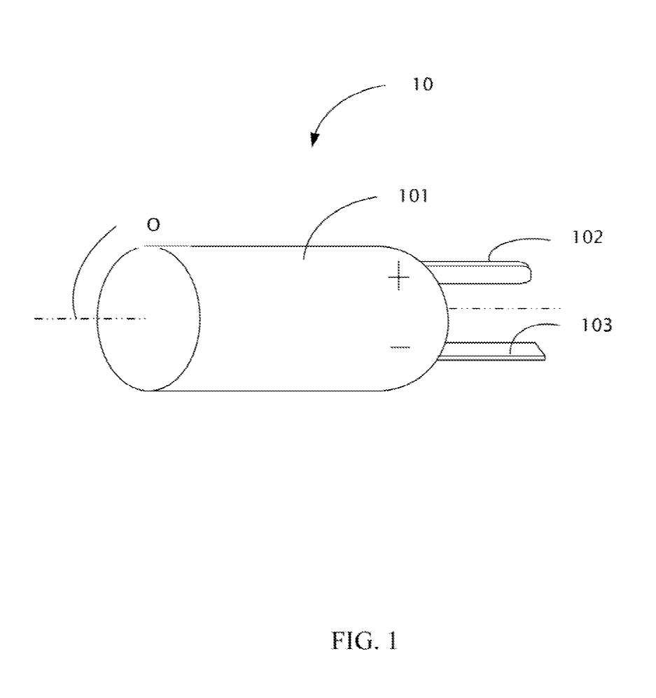

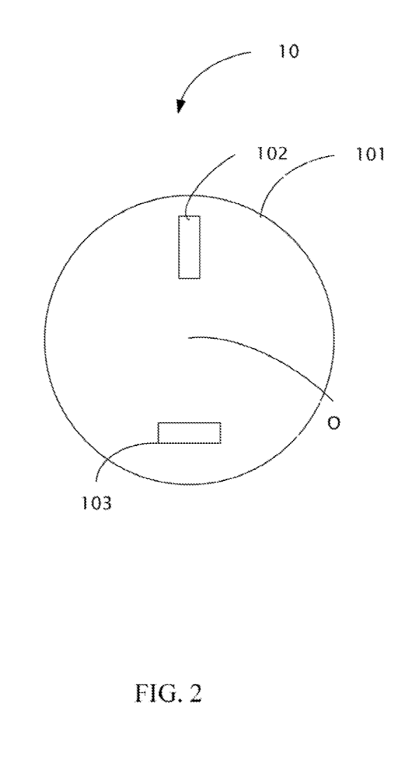

FIGS. 1 and 2 show an embodiment of a solid capacitor 10. The solid capacitor 10 includes a body 101, a positive connection terminal 102, and a negative connection terminal 103. The body 101 is cylindrical having a lengthwise central axis 0. The positive connection terminal 102 and the negative connection terminal 103 are strips extending from an end of the body 101 along the central axis. That is, length directions of the positive connection terminal 102 and the negative connection terminal 103 are substantially parallel with a length direction of the body 101. Width directions of the positive connection terminal 102 and the negative connection terminal 103 are substantially perpendicular to each other. In detail, the central axis O falls within a plane defined by the width direction and the length direction of the positive connection terminal 102 while is substantially parallel with a plane defined by the width direction and the length direction of the negative connection terminal 103.

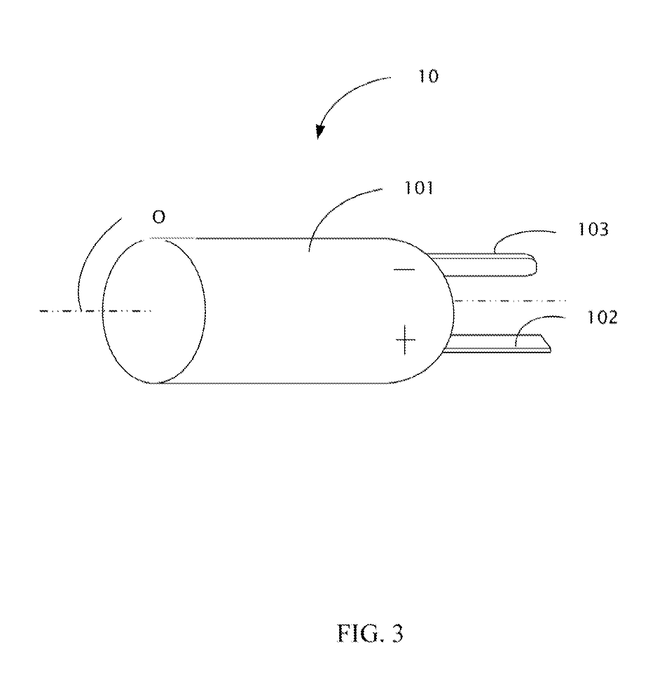

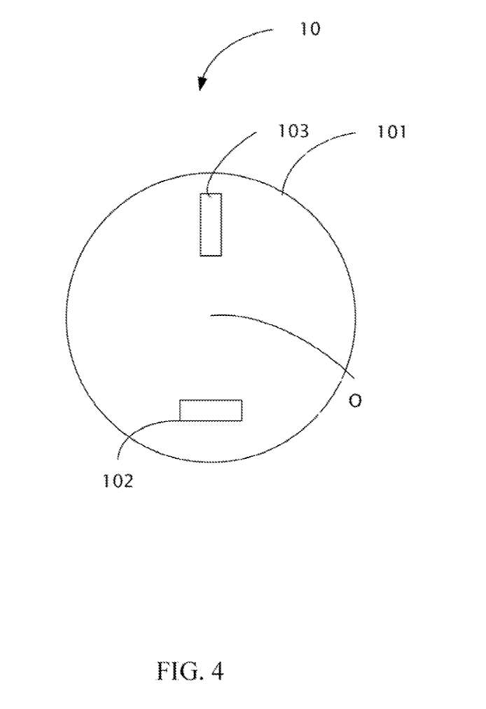

Referring to FIGS. 3 and 4, as compared with the solid capacitor 10, in a slid capacitor 10′ of another alternative embodiment, the central axis 0 falls in the plane defined by the width direction and the length direction of the negative connection terminal 103 while is substantially parallel with a plane defined by the width direction and the length direction of the positive connection terminal 102.

As such, a loop area between the positive connection terminal 102 and the negative connection terminal 103 can be efficiently reduced, thereby decreasing ESL of the solid capacitor 10 and 10′. In addition, the positive connection terminal 102 and the negative connection terminal 103 can be easily identifiable from each other.

Sizes of the positive connection terminal 102 and the negative connection terminal 103 can be changed according to a size of the solid capacitor 10 and 10′ to satisfy actual requirements. The solid capacitor 10 and 10′ may be an OS-CON capacitor.

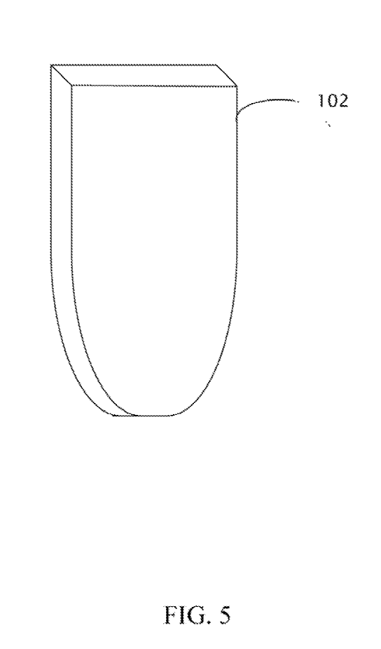

FIG. 5 shows that the positive connection terminal 102 is blade shape. The blade shape of the positive connection terminal 102 makes the positive connection terminal 102 be easily inserted into slots.

In other embodiments, both of the positive connection terminal 102 and the negative connection terminal 103 can be set to be blade shape. In other embodiments, one of the positive connection terminal 102 and the negative connection terminal 103 can be set to be the blade shape.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A solid capacitor comprising:
a body; and
a strip-shaped positive connection terminal and a strip-shaped negative connection terminal extending from the body;
wherein length directions of the positive connection terminal and the negative connection terminal are substantially parallel with each other while width directions of the positive connection terminal and the negative connection terminal are substantially perpendicular to each other.

2. The solid capacitor of claim 1, wherein the body is cylindrical and has a lengthwise central axis, the length direction of the positive connection terminal and the negative connection terminal are substantially parallel with the central axis.

3. The solid capacitor of claim 2, wherein the central axis falls within a plane defined by the width direction and the length direction of the positive connection terminal while is substantially parallel with a plane defined by the width direction and the length direction of the negative connection terminal.

4. The solid capacitor of claim 2, wherein the central axis 0 falls in the plane defined by the width direction and the length direction of the negative connection terminal 103 while is substantially parallel with a plane defined by the width direction and the length direction of the positive connection terminal 102

5. The solid capacitor of claim 1, wherein both of the positive connection terminal and the negative connection terminal are set to be a blade shape.

6. The solid capacitor of claim 1, wherein the positive connection terminal is set to be a blade shape.

7. The solid capacitor of claim 1, wherein the negative connection terminal is set to be a blade shape.

8. The solid capacitor of claim 1, wherein the solid capacitor is an OS-CON capacitor.
